(19) United States
(12) Patent Application Publication
(10) Pub. No.: US 2004/0063463 A1
(43) Pub. Date: Apr. 1, 2004

(54) Multiple piece wireless phone

(76) Inventor: Roger Boivin, Melissa, TX (US)

Correspondence Address: SUGHRUE MION, PLLC, 2100 PENNSYLVANIA AVENUE, N.W., SUITE 800, WASHINGTON, DC, 20037, US

(21) Appl. No.: 10/673,567

(22) Filed: Sep. 30, 2003

Related U.S. Application Data
(60) Provisional application No. 60/414,346, filed on Sep. 30, 2002.

(51) Int. Cl. H04M 1/00

(52) U.S. Cl. 455/558

(57) ABSTRACT

A two piece wireless phone is disclosed. Preferably, the wireless phone is comprised of two modules. The first module preferably comprises the functional components of a wireless phone. The second module comprises the user interface components, and enables a user to operate the wireless phone. In one embodiment, the first module is reusable while the second module is interchangeable. The first module includes a connection area that is engageable with a connection area included in the second module. Because the functional components of the wireless phone are not included in the second module, the cost of replacing the second module is minimized.

### CROSS-REFERENCE TO RELATED APPLICATIONS

The benefit of provisional application No. 60/414,346 filed Sep. 30, 2002 under 35 U.S.C. § 119(e), is hereby claimed.

### FIELD OF THE INVENTION

The present invention relates to a disposable, recyclable, or tradeable instant use wireless phone. More specifically, the present invention relates to a two piece disposable wireless phone that allows users to discard, recycle, trade, or accessorize one piece and reuse the other.

### BACKGROUND OF THE INVENTION

Wireless communication devices operate on a wireless network to provide a user of the device with portable communications. Typically, wireless communications devices communicate with a wireless network based on electromagnetic signals, such as those in the radio frequency range. Wireless communication devices may communicate voice, data, or video. The devices may be either analog or digital, depending on the type of wireless network. Examples of such devices are radio-telephones, pagers, two-way radios, personal data assistants, and personal computers.

Typically, wireless devices operate by scanning a predetermined set of frequency channels associated with a particular network provider. The device then selects the channel that it determines to be the strongest, and dwells on it. Either simultaneously, or soon after selecting a channel, the wireless device performs a process known as system registration. The system registration process allows a network to determine which devices are currently active, and is repeated periodically. This allows a network provider to determine the communications load of the network.

One type of wireless communications device that has become especially ubiquitous is wireless telephones. The widely expanding market for wireless phones is due in part to the expanding coverage areas and better reception. In addition, lower prices and smaller phones have resulted from increased manufacturing volumes. Wireless phones are now frequently used to satisfy business and personal needs.

While wireless phones are a necessity for some, they still remain a luxury for a large number of people because acquiring a wireless phone today is a complicated process. The wireless carriers require extensive personal data, credit checking, rate plan analysis, and activation processes before the end customer can use the phone. This invention will change this paradigm by making the wireless handset separate from the majority of the electronics and making the phone as simple to purchase and use as a disposable camera: Walk in, pay cash, walk out, turn the phone on and talk. Customers will be able to reuse the phone if they desire by buying additional handsets or minute replenishment packages. The separation of the electronics and the handset combined with the simplicity of the replenishment process results in an affordable handset for the end user and positive margin for the provider of this two-piece phone.

Currently, in an effort to remain competitive, wireless providers are constantly changing their subscription plans, changing their rates and offering additional services confusing consumers who may only want the ability to simply communicate while mobile.

Wireless providers have also continued to upgrade to phones with more features because they believe it is a requirement to remain competitive. They, in most cases make the devices/phones available at little or no cost, working on the premise that the consumer will use the phone extensively and maintain service for a contracted period of one to three years. The cost of infrastructure, phone buy down, contracts and information tracking on customers, phone maintenance, upgrades, billing, customer service and all the support teams to provide service to the end customer are all very expensive. Additionally, the customer must have a sound credit background, be willing to sign a contract, and sign up for a service plan with included minutes and features—regardless if they use all of them, they are charged for the contract signed.

Additionally, wireless providers like their landline counterparts require a relationship with the customer. This is referred to as a “subscriber” mentality within the industry. They want an account set up with the customer's name, address, rate plan, features, etc. Even in their prepaid programs, wireless providers want a recurring connection with their customers and typically accomplish this through a monthly access fee or replenishment process that forces the customer to be explicitly known to the wireless carrier.

Consumers change their phones to replace a defective or broken unit, a lost or stolen phone or because they would like a different look. Since the consumer is now a subscriber of a wireless provider, there is no incentive for the provider to discount the unit resulting in significant cost to the consumer. This invention allows consumers to purchase a new handset for a very low cost allowing a consumer to own several different color sublimated phones.

Some companies have attempted to reduce the costs of purchasing and owning a wireless phone in order to appeal to a broader market by manufacturing disposable phones. These disposable phones are still expensive and are being sold below cost with the hopes that users will purchase additional minutes for the company to make a profit. Other approaches have involved reusable phones that similarly have a finite duration in which they may be used. However, instead of discarding the phone once its minutes of use have expired, a consumer may take it back to a retail center to have the lifetime extended or use a credit card to obtain a code that adds minutes of use in the phone.

Both of these approaches have significant disadvantages. Disposable phones, while often constructed from cheaper materials, still require a consumer to have good credit history, provide extensive amount of personal data, spend significant amount of time to obtain service and sign up for a rate plan with a reoccurring charge.

### SUMMARY OF THE INVENTION

The present invention relates to a two piece wireless phone. One piece of the wireless phone may be interchanged to give the wireless phone a new user interface. The user interface may include the overall appearance of the phone, display colors, shape, size, speakers, keypad, or the like. The other piece of the wireless phone, which comprises the functional components of the wireless phone, may be reused with any number of different user interfaces. Typically, the costs of functional components, such as electronics and the like exceed the costs of user interface components such as a keypad, earpiece, or the like. By separating the functional components of the wireless phone from the user interface components, the present invention is able to reduce the costs associated with changing the aesthetic properties of a wireless phone.

In one embodiment, the present invention is a wireless phone comprising one reusable module, and one disposable module. The reusable module preferably comprises functional components including a subscriber identification module, and at least one of a transmitter, receiver, processor, and a memory. Other functional components may be power amplifiers, semi-conductors, and switches.

In this embodiment, the wireless phone may operate at any desired frequency. In some embodiments, the wireless phone may be capable of operating a multiple frequencies, either at different times or simultaneously. Preferably, the wireless phone operates between a 50 and 100 MHz range of a network provider's operating frequency. More preferably, the wireless phone operates between a 25 and 50 MHz range of a network provider's operating frequency.

A protective cover is preferably configured and adapted to house the functional components. The protective cover should isolate the functional components from its environment, and preferably prevents them from being damaged. In one embodiment, the protective cover also includes a connection area having standardized dimensions. It is desired that the protective cover is configured and adapted to fit within a defined profile. The length of the profile is preferably between about 40 and about 50 mm. The width of the profile is preferably between about 25 and about 35 mm. The height is preferably between about 3 and about 6 mm.

In one embodiment, the disposable module comprises a user interface module. The user interface module comprises at least some of a case, microphone, display, keypad, speaker, earpiece, hands free jack, volume control, on/off switch, and DRAM. Similar to the reusable module, the disposable module is configured and adapted to fit a defined profile. It is also desired that the disposable module is configured and adapted to house a power source, such as AA batteries. The disposable module is preferably operatively connectable to the reusable module.

It is desired that by separating the functional components from the user interface components, the cost of a wireless phone may be reduced. In one embodiment, the disposable module comprises about 10% or less of the total cost of the two modules. In another embodiment, the disposable module comprises about ⅛ or less of the cost of the reusable module.

In yet another embodiment, the present invention comprises an apparatus for transmitting data over a wireless network. The apparatus comprises a module comprising functional components and a sensing device operatively connected to the functional component module. In this embodiment, the functional components comprise a subscriber identification module. The functional components further comprise at least one of a transmitter, receiver, and processor. Power amplifiers, semi-conductors, and switches may also be included among the functional components. The functional components preferably operate at between a 50 to 100 MHz range of a network providers operating frequency. More preferably, they operate between a 25 to 50 MHz range of a network providers frequency. A protective cover is preferably configured and adapted to house the functional components.

In some embodiments, the disposable module may be modified for promotional purposes with large companies at trade shows, as a gift for signing up, reward programs, and as a gift for trial or intent to purchase. This channel offers sales opportunities to a wide variety of events and generally unique demographics. This two piece phone will be used to meet specific requirements of an event and will be customized through sublimation with specific graphics. In one embodiment, the appearance of the phone may be designed to include the logo of a sports team, such as the Dallas Cowboys.

### BRIEF DESCRIPTION OF THE DRAWINGS

FIG. 1 is a diagram showing the frequency range of exemplary wireless phones;

FIG. 2 is a diagram showing exemplary modules according to the present invention;

FIG. 3 is a diagram showing one exemplary module according to the present invention; and

FIG. 4 is a diagram showing exemplary novelty phones according to the present invention.

### DETAILED DESCRIPTION OF THE PREFERRED EMBODIMENTS

The present invention relates to a two piece wireless phone. One piece of the wireless phone may be interchanged to give the wireless phone a new user interface. The user interface may include the overall appearance of the phone, display colors, shape, size, speakers, keypad, or the like. The other piece of the wireless phone, which comprises the functional components of the wireless phone, may be reused with any number of different user interfaces. Typically, the costs of functional components, such as electronics and the like exceed the costs of user interface components such as a keypad, earpiece, or the like. By separating the functional components of the wireless phone from the user interface components, the present invention is able to reduce the costs associated with changing the aesthetic properties of a wireless phone.

Each piece of the present invention is referred to as a module. As described above, one module includes the functional components of the wireless phone. It is desirable for this module to function independently of the user interface module. As such, the functional component module is capable of transmitting and receiving wireless signals over a wireless network. It is desirable that the functional component module may be employed as a signaling device in a variety of applications, which will be discussed in greater detail below.

It is desired that the present invention establishes a standard for two piece wireless phones. Preferably, the functional component module interface has standard dimensions, which can be adapted for use with any user component module. As technology changes and evolves, the functional component module may be updated to adapt to these changes. The module design may be altered to accommodate changes in chip design, transistor technology, wireless standards, network frequencies, or the like. Because of the standard dimensions of the module interface, the manufacturing costs associated with updating the technology are significantly reduced.

According to one aspect of the present invention, the wireless phone comprises two separate modules. A first module is preferably reusable, and may comprise all or substantially all of the functional components that are necessary for a wireless phone to function. The first module may be referred to as an Expanded Subscriber Identification Module (“ESIM”). The second module is preferably interchangeable or disposable, and comprises the user interface components of a. wireless phone. This module may be referred to as a Disposable/Reusable Wireless Phone (“DRWP”). By operatively connecting the ESIM with the user interface components of the DRWP, the wireless phone of the present invention facilitates use by an end user.

When constructing a wireless phone according to the present invention, it is desirable to place a majority of the functional components of the phone in a first, reusable module. For instance, the first module may comprise a receiver, processor, and transmitter to handle wireless signals. The processor may include any electrical device, such as a circuit board, one or more semiconductors, chip sets, or the like. A memory may also be included. In addition to assisting other components of the ESIM, the memory may be used to store data that is important to a user, such as phone numbers or addresses. As explained below, other functional components also may be disposed within the reusable module. Because the functional components of a wireless phone often comprise a disproportionate amount of the cost of manufacturing a phone, it is desirable to reuse these components.

In one embodiment, the present invention is capable of being developed for use on any wireless network. In one embodiment, the wireless network is digital, though in other embodiments the network may be analog. The wireless network may be based on any protocol known to those skilled in the art. The protocols may include, but are not limited to, Global System for Mobile Communication (GSM), Code Division Multiple Access (CDMA), or Voice over IP (V/IP).

When a wireless phone is activated, it is desirable for the phone to inform a network provider of its active status. This may be accomplished by using a variety of methods or apparatus. In one embodiment, the phone may provide the network with a unique code or identifier. In another embodiment, the phone may send an encrypted signal to the network. By notifying the network of its active status, the phone identifies itself and enables the phone to begin sending and receiving wireless signals over the wireless network. In one embodiment, the ESIM is capable of notifying the network provider of its active status and providing identifying information about itself. Preferably, this is accomplished through the use of a Subscriber Identification Module (“SIM”) disposed within the ESIM. The SIM is capable of identifying a particular phone to a network provider. The status notification and identifying may be based on any computing device, processor, chip, or the like.

In one embodiment, the wireless phone according to the present invention is based on a GSM network. Wireless phones that use a GSM network typically include a SIM card. The SIM card is responsible for identifying the phone. Thus, the SIM card can allow a user to transfer the subscriber identity to any GSM compatible phone. In one embodiment of the present invention, the SIM card that is typically used with GSM networks is included in the ESIM of the present invention. In combination with the other functional components of the ESIM, the SIM card allows a user to transfer their subscriber identity to any DRWP.

In order to communicate with the network provider, the functional components of the ESIM may include radio frequency transmit and receive components. These components are well known to those skilled in the art. In one embodiment, the transmit and receive components are operatively connected to the other components of the ESIM. In such an embodiment, this allows the ESIM to communicate with the network provider.

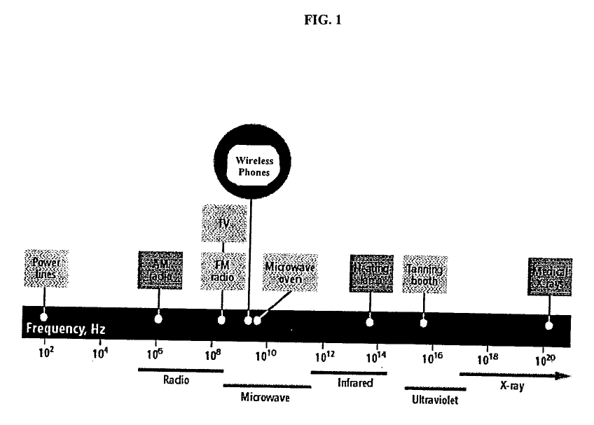

The transmitter and receiver components may operate at any frequency range or may be able to communicate at multiple frequency ranges. Preferably, the frequency range is compatible with a particular network provider. As shown in FIG. 1, wireless phones currently operate at frequency ranges of the electromagnetic spectrum that fall between the frequency ranges of microwave ovens and TV transmitters. In one embodiment, the transmitter and receiver components preferably operate between about 800 and about 900 MHz. More preferably, the components operate between about 840 and about 860 MHz.

In other embodiments, a higher operating frequency may be desired. In this embodiment, the operating frequency is between about 1750 to about 1950 MHz. More preferably, the operating frequency is between about 1800 to about 2000 MHz. In other embodiments, any combination of the high and low limits of the above ranges may be used. For example, in some embodiments it may be desirable to have an operating frequency that is between about 800 and about 1900 MHz. In another embodiment, the operating frequency may comprise a selectable channel or frequency. In this embodiment, each selectable channel frequency is preferably within about 25 MHz of the network provider frequency. More preferably, each channel frequency is within about 100 MHz, and most preferably the frequency range of each selectable channel is within about 200 MHz of the network provider frequency. However, the present invention is not intended to be limited to any specific frequency range. In other embodiments, the frequency ranges can be changed to accommodate a particular wireless standards or network frequencies. If a network provider operates at more than one frequency range, a channel may be selected for each range.

Wireless phone technology is constantly being upgraded with better and more densely populated components reducing component count and price. Additionally, functionality increases which allow phones to automatically operate on multiple frequency bands using multiple technologies. This allows the ESIM, according to the present invention, to keep up with these technological innovations. It is desirable to allow the ESIM to be upgraded with newer technology.

In one embodiment, as technology changes, an ESIM can be updated to account for these advances. The updates can incorporate changes in chip design, transistor technology, wireless standards, network frequencies, or the like. By providing a standard design for ESIM, consumer costs for purchasing a new ESIM can be significantly reduced.

As described above, the ESIM includes the functional components of a wireless phone. When it is not connected to the DRWP, an ESIM may be capable of transmitting and receiving signals over a wireless network. For example, the ESIM may be used separately for data applications by operatively connecting a sensor to the ESIM. Once the desired data is obtained, the ESIM may be signaled to transmit the data over the network to a desired receiver.

In one embodiment, the ESIM may be used in a remote area to transmit sensor information back to an information center. In this embodiment, an ESIM may be operatively connected to a sensing device. For example, the sensing device may be capable of detecting water levels of a body of water. When the body of water falls below a predetermined level, the sensor will transmit this information to the ESIM. The ESIM may then transmit the data, via a wireless network, to an information center. The present invention is not intended to be limited to a water sensor but may be used with other sensing devices, such as burglar alarms, weather instruments, fire alarms, gas sensors, radiation detectors, and the like may be used. Any mechanical, chemical, or electrical device may be operatively connected to the ESIM.

In addition to the components described above, the ESIM may also include other electronic components that are necessary for a wireless phone to function. These components may include power amplifiers, switches, semi-conductors or the like. In one embodiment, the ESIM functional components, as described above, may be mounted onto a printed circuit board (PCB). The physical characteristics of the ESIM will be described in more detail below.

In one embodiment, the ESIM of the present invention is preferably able to operatively connect with a variety of DRWP's. In order to allow an ESIM to operatively connect with a DRWP, the ESIM may have predetermined dimensions, including shape, size, and the like. The dimensions of the ESIM allow manufacturers to selectively configure the DRWP user interface module such that it is able to accommodate any ESIM.

In other embodiments, the connection area may be the same, but the size of the DRWP may differ. In such an embodiment, the connection area preferably has standard dimensions. The dimensions, including the shape and size of the DRWP may be varied as long as the connection area conforms to standard dimensions. The dimensions of the connection area are described in more detail below.

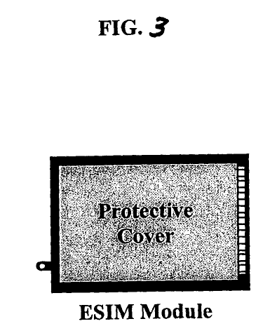

In one embodiment, shown in FIG. 3, the ESIM includes a housing that serves as a protective cover. It is desired that the protective cover prevents damage to, or interference with, the functional components that are included in the ESIM. The protective cover preferably includes a connection area 301 and guides for connecting an ESIM with a DRWP. The shape and dimensions of the protective cover should be sufficient to house all of the ESIM functional components.

In one embodiment, the ESIM, which includes the protective cover, connection area 301, and guides, has physical properties that are similar to those of a PCMCIA card. The standard dimensions of the PCMCIA card allow computer manufacturers to design ports that are capable of engaging with the PCMCIA card. In a similar manner, the standard dimensions of the ESIM allow DRWP manufacturers to design user interfaces that are capable of engaging with the ESIM.

In one embodiment, the connection area of the ESIM is also standardized. It is desired that the connection area 301 allows the ESIM to interface with the DRWP. This allows communication between the two modules that may include transferring information, including data or signals. As such, the physical connection area remains standard while the data transfer can be varied as desired. In one embodiment, the connection area 301 of the ESIM preferably comprises one or more male protrusions. The male protrusions are preferably engageable with corresponding female receptacles of the DRWP. This connection scheme is typically found on PCMCIA cards, and is well known to those skilled in the art.

The protective cover may also include guides that assist in engaging the protrusions and receptacles. The guides may also include a mechanical device that assists in ejecting the ESIM from the DRWP, as commonly found in PCMCIA computers. In one embodiment, the guides are located along two opposing edges of a rectangular protective cover. Corresponding guides are included in the DRWP. It is desired that the guides aid a user in connecting the ESIM with a DRWP. Any guides known to those skilled in the art, such as tracks or the like, may be used with the present invention.

In one embodiment, the ESIM is configured and adapted to fit within a certain dimension or overall profile. In order to fit within this profile, the length, width and height of the ESIM may be standardized. Preferably, the length of the ESIM is between about 10 and about 90 mm. More preferably, the length of the ESIM is between about 35 and about 60 mm, and most preferably the length is between about 40 and about 50 mm. Preferably, the width of the ESIM is between about 10 and about 50 mm. More preferably, the width of the ESIM is between about 20 and about 40 mm, and most preferably the width is between about 25 and about 35 mm. The height of the ESIM is preferably between about 1 and about 10 mm. More preferably, the height of the ESIM is between about 2 and about 8 mm, and most preferably the height is between about 3 and about 6 mm.

In this embodiment, the DRWP receptacle is similarly configured and adapted to fit the standardized dimensions of the ESIM. The DRWP overall dimension is unlimited provided that it exceeds the dimensions of the ESIM and corresponding receptacle.

In one embodiment, as described above, the DRWP according to the present invention preferably comprises the user interface components of a wireless phone. Typically, user interface components are less expensive than the functional components described with respect to the ESIM. It is desired that by minimizing the number of functional components present, the cost of the DRWP is minimized. One advantage of reducing the cost of the DRWP is that a user may choose to own multiple or additional DRWP's.

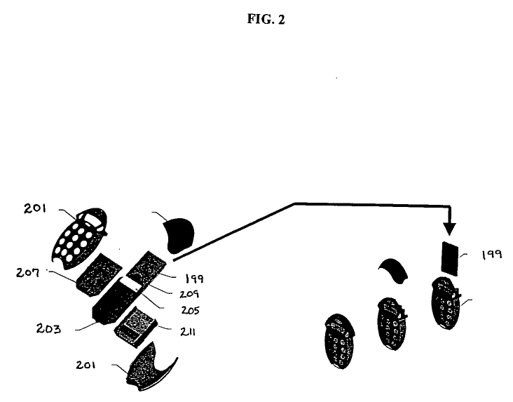

In one embodiment, the DRWP comprises equipment that allows a user to operate a wireless phone. As shown in FIG. 2, this equipment may include, but is not limited to, a case 201, microphone 203, display 205, keypad 207, speaker 209, earpiece, hands-free jack, volume control, on/off switch, and the like. Despite the fact that electronic components, such as a display 205 or speaker 209, may be included in the DRWP, these components are only necessary to enable a user to operate a wireless phone. In this embodiment, these electronic components are not required to assist the ESIM in connecting to or communicating with a wireless network.

As previously described, the DRWP is preferably configured to allow easy insertion and removal of the ESIM. Along these lines, it is desired that the DRWP includes a connection area that is configured and positioned to engage with the male protrusions of the ESIM, as described above. In some embodiments, the DRWP may also have guides that correspond to ESIM guides, thereby allowing easier insertion. The dimensions of the DRWP, including its shape and size, may be varied as desired. The shape may be rectangular, circular, square, or the like. It is desired, however, that the shape of the DRWP does not prevent it from engaging with the ESIM.

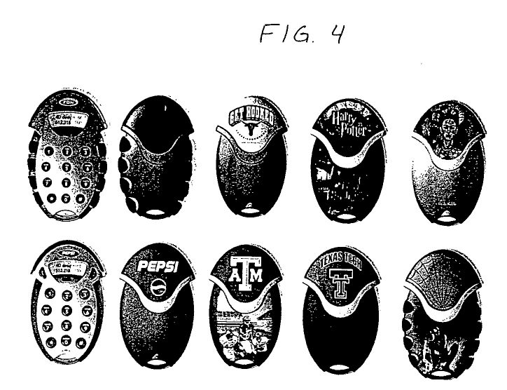

In one embodiment, the DRWP may also include Dynamic Random Access Memory (DRAM), that may be used to store data. This data may include, ring tones, graphics, games, or the like. The inclusion of DRAM allows a DRWP manufacturer to easily personalize the user interface. A DRWP may be configured and adapted in any desired manner. For example, in some embodiments a user interface may be modified for promotional purposes with larger companies at trade shows, as a gift for signing up, reward programs, and as a gift for trial or intent to purchase. This channel offers sales opportunities to a wide variety of events and generally unique demographics. This two piece phone will be used to meet specific requirements of an event and will be customized through sublimation with specific graphics. In one embodiment, the appearance of the phone may be designed to include the logo of a sports team, such as the Dallas Cowboys. In other embodiments, the appearance or ringtones may be personalized to promote movies such as Harry Potter or Spiderman, as shown in FIG. 4. In another embodiment, a phone may resemble a movie character, such as Darth Vader from the movie Star Wars. DRWP's may also be personalized to have different shapes or colors, as described above. In one embodiment, the shape of the DRWP may be designed to look like fruit, beer cans, action figures, movie characters, and the like. Personalizing a DRWP may also allow a user to match the color of their phone to their outfit on a particular day.

Eliminating a majority of the functional components from the DRWP significantly reduces the manufacturing cost. In one embodiment, the cost of the DRWP is preferably about ½ or less of the cost of the ESIM. More preferably, the cost of the DRWP is about ⅛ or less of the cost of the ESIM, and most preferably the cost is about 1/20 or less of the cost of the ESIM. In another embodiment, the cost of the DRWP is preferably less than about 20 U.S. dollars (USD). More preferably, the cost of the DRWP is less than about 10 USD, and most preferably the cost of the DRWP is less than about 5 USD. In yet another embodiment, the cost of the DRWP is preferably about 20% or less of the total cost of the DRWP and the ESIM. More preferably the cost of the DRWP is about 10% or less, and most preferably the DRWP is about 5% or less of the total cost of the DRWP and the ESIM.

The present invention requires power to operate. In one embodiment, a rechargeable power source may be included with the DRWP or separately as a replaceable battery module 211. In another embodiment, the DRWP may include a housing for the power source. Because power sources, such as rechargeable batteries are typically expensive, a power source housing can accommodate any type of power source, such as standard AA batteries to minimize the cost of the DRWP. Any battery may be used, including power cells, lithium-ion, alkaline, or the like.

As described with reference to the embodiments above, the present invention is capable of providing a two piece wireless phone. In one embodiment, the ESIM 199 may be transferred to any DRWP, as shown in FIG. 2. In this embodiment, the DRWP may be reusable or disposable. A user may purchase a variety of DRWP's, in different colors, shapes, or sizes. When a user wants to change their DRWP, for example, to match the color of their wireless phone to their clothing or apparel, the ESIM may be ejected from the DRWP. It may then be placed in another DRWP, using the connection area and guides previously described.

Though one embodiment of the present invention has been described with reference to a DRWP that has mainly user interface components, this is not intended to limit the present invention. In other embodiments, the ESIM may be operatively connected with any type of device, such as computers, processing devices, Personal Digital Assistant's (PDA's), and the like.

Although the present invention has been described with reference to particular embodiments, it will be understood to those skilled in the art that the invention is capable of a variety of alternative embodiments within the spirit of the appended claims.

1. A wireless phone, comprising:
one reusable module; and
one disposable module.

2. The wireless phone according to claim 1, wherein the reusable module comprises functional components.

3. The wireless phone according to claim 2, wherein the functional components comprise a subscriber identification module.

4. The wireless phone according to claim 2, wherein the functional components further comprise at least one of a transmitter, receiver, processor and a memory.

5. The wireless phone according to claim 2, wherein the functional components further comprise at least one of power amplifiers, semi-conductors, and switches.

6. The wireless phone according to claim 2, wherein the functional components operate between a 25 and 50 MHz range of a network provider's operating frequency.

7. The wireless phone according to claim 2, wherein the functional components operate between a 50 and 100 MHz range of a network provider's operating frequency.

8. The wireless phone according to claim 2, wherein a protective cover is configured and adapted to house said functional components.

9. The wireless phone according to claim 8, wherein said protective cover comprises a connection area, wherein said connection area has standardized dimensions.

10. The wireless phone according to claim 8, wherein said protective cover is configured and adapted to fit within a defined profile, said profile comprising a length, a width, and a height.

11. The wireless phone according to claim 10, wherein said length is between about 40 and about 50 mm.

12. The wireless phone according to claim 10, wherein said width is between about 25 and about 35 mm.

13. The wireless phone according to claim 10, wherein said height is between about 3 and about 6 mm.

14. The wireless phone according to claim 1, wherein said disposable module comprises a user interface module, said user interface module comprising at least some of a case, microphone, display, keypad, speaker, earpiece, hands-free jack, volume control, on/off switch, and DRAM.

15. The wireless phone according to claim 1, wherein said disposable module is configured and adapted to fit a defined profile, said profile comprising a length, a width, and a height.

16. The wireless phone according to claim 1, wherein said disposable module is configured and adapted to house a power source.

17. The wireless phone according to claim 1, wherein said disposable module is operatively connectable to said reusable module.

18. The wireless phone according to claim 1, wherein said disposable module comprises about 10% or less of the total cost of the disposable module and the reusable module.

19. The wireless phone according to claim 1, wherein said disposable module comprises about ⅛ or less of the cost of the reusable module.

20. A wireless phone, comprising:
one reusable module comprising functional components; and
one disposable module comprising user interface components.

21. The wireless phone according to claim 20, wherein the functional components comprise a subscriber identification module.

22. The wireless phone according to claim 20, wherein the functional components further comprise at least one of a transmitter, receiver, processor, and a memory.

23. The wireless phone according to claim 20, wherein the functional components further comprise at least one of power amplifiers, semi-conductors, and switches.

24. The wireless phone according to claim 20, wherein the functional components operate between a 25 and 50 MHz range of a network provider's operating frequency.

25. The wireless phone according to claim 20, wherein the functional components operate between a 50 and 100 MHz range of a network provider's operating frequency.

26. The wireless phone according to claim 20, wherein a protective cover is configured and adapted to house said functional components.

27. The wireless phone according to claim 26, wherein said protective cover comprises a connection area, wherein said connection area has standardized dimensions.

28. The wireless phone according to claim 26, wherein said protective cover is configured and adapted to fit within a defined profile, said profile comprising a length, a width, and a height.

29. The wireless phone according to claim 28, wherein said length is between about 40 and about 50 mm.

30. The wireless phone according to claim 28, wherein said width is between about 25 and about 35 mm.

31. The wireless phone according to claim 28, wherein said height is between about 3 and about 6 mm.

32. The wireless phone according to claim 20, wherein said user interface components, said user interface components comprising at least some of a case, microphone, display, keypad, speaker, earpiece, hands free jack, volume control, on/off switch, and DRAM.

33. The wireless phone according to claim 20, wherein said disposable module is configured and adapted to fit a defined profile, said profile comprising a length, a width, and a height.

34. The wireless phone according to claim 20, wherein said disposable module is configured and adapted to house a power source.

35. The wireless phone according to claim 20, wherein said disposable module is operatively connectable to said reusable module.

36. The wireless phone according to claim 20, wherein said disposable module comprises about 10% or less of the total cost of the disposable module and the reusable module.

37. The wireless phone according to claim 20, wherein said disposable module comprises about ⅛ or less of the cost of the reusable module.

38. An apparatus for transmitting data over a wireless network, comprising:
a module comprising functional components; and
a sensing device operatively connected to said functional component module.

39. The wireless phone according to claim 38, wherein the functional components comprise a subscriber identification module.

40. The wireless phone according to claim 38, wherein the functional components further comprise at least one of a transmitter, receiver, and processor.

41. The wireless phone according to claim 38, wherein the functional components further comprise at least one of power amplifiers, semi-conductors, and switches.

42. The wireless phone according to claim 38, wherein the functional components operate between a 25 and 50 MHz range of a network provider's operating frequency.

43. The wireless phone according to claim 38, wherein the functional components operate between a 50 and 100 MHz range of a network provider's operating frequency.

44. The wireless phone according to claim 38, wherein a protective cover is configured and adapted to house said functional components.
